(19) United States
(12) Patent Application Publication
(10) Pub. No.: US 2019/0011906 A1
(43) Pub. Date: Jan. 10, 2019

(54) METHOD AND SYSTEM FOR MAINTENANCE OF AT LEAST ONE OF A PLURALITY OF FIELD DEVICES IN A PLANT OF AUTOMATION TECHNOLOGY

(71) Applicant: Endress+Hauser Process Solutions AG, Reinach (CH)

(72) Inventors: Marc Baret, Kembs (FR); Georg Hauss, Freiburg (DE); Ulrich Kaiser, Basel (CH); Michael Maneval, Schopfheim (DE); Markus Nick, Kembs (FR)

(21) Appl. No.: 15/753,860

(22) PCT Filed: Jul. 26, 2016
(86) PCT No.: PCT/EP2016/067752

§ 371 Date: Feb. 20, 2018

(30) Foreign Application Priority Data
Aug. 24, 2015 (DE) 10 2015 113 981.2

(51) Int. Cl. G05B 23/02; G05B 19/406

(52) U.S. Cl. CPC G05B 23/0283; G05B 2219/31337; G05B 19/406

(57) ABSTRACT

The invention describes a method and a system for maintenance of at least one of a plurality of field devices in a plant of automation technology, comprising a plurality of field devices; a database for storing particular device types of the plurality of field devices, diagnostic reports of the plurality of field devices, failure pictures, measures applied in the past for removing a failure, which has occurred, and success evaluations for the particular, stored measures; and a computing unit, which accesses the database and can read out, store and/or associate data there, as well as creates success evaluations and compares new diagnostic reports with the failure pictures stored in the database and displays a proposal of a measure appropriate therefor and its success evaluation.

The invention relates to a method and system for maintenance of at least one of a plurality of field devices in a plant of automation technology, which system comprises a plurality of field devices, a database for storing device types of the plurality of field devices, diagnostic reports of the plurality of field devices, failure pictures, measures applied in the past for removing a failure, which has occurred, and success evaluations for the stored measures, and a computing unit, which accesses the database and can read out, store and/or associate data there, as well as creates success evaluations and compares new diagnostic reports with the failure pictures stored in the database and displays a proposal of a measure appropriate therefor and its success evaluation.

Known from the state of the art are field devices, which are used in industrial plants. In automation technology, especially process automation and manufacturing automation technology, large numbers of field devices are applied. Referred to as field devices are, in principle, all devices, which are applied near to the process and which deliver, or process, process relevant information. Thus, field devices are used for registering and/or influencing process variables. Serving for registering process variables are measuring devices, i.e. sensors. These are used, for example, for pressure- and temperature measurement, conductivity measurement, flow measurement, fill level measurement, etc. and register the corresponding process variables, pressure, temperature, conductivity, pH-value, fill level, flow etc. Used for influencing process variables are actuators. These are, for example, pumps or valves, which can influence the flow of a liquid in a pipe or tube or the fill level in a container. Besides the above mentioned measuring devices and actuators, understood as field devices are also remote I/Os, radio adapters, and generally devices, which are arranged at the field level.

A large number of such field devices are produced and sold by the Endress+Hauser group of firms.

A failure of such a field device is associated with high costs and occasionally consumes an immense amount of time. Depending on the application of the failed field device, the entire process of the plant, in which the field device is installed, may have to be interrupted, the field device deinstalled and subjected to maintenance, and then installed anew, back into the plant.

A field device, which detects a malfunction, for example, measured values deviating from the standard, independently sends diagnostic reports to the plant control room. For a plant operator, it can, however, be difficult, based on these diagnostic reports, to take suitable measures, which lead to a fast and reliable removal of the problem.

Maintenance experts called for problem identification and/or for problem cure bring about additional expenditure of time and money. Now and then, even maintenance experts require considerable time, in order to select a suitable measure, since each diagnostic report must be individually evaluated and analyzed based on the individual experience of the particular maintenance experts.

Starting from this above described problem, an object of the invention is to provide method and system enabling failure of a field device to be rapidly and efficiently eliminated.

The object is achieved by a method for maintenance of at least one of a plurality of field devices in a plant of process automation, comprising steps as follows:
registering at least one process location of the plant in a database;
associating a process application to the process location in the database;
registering particular device types of the plurality of field devices associated with the process location and storing the device types in the database (2);
registering diagnostic reports of the plurality of field devices, associating the diagnostic reports with the particular device types and storing the diagnostic reports in the database;
creating failure pictures from the stored diagnostic reports, which represent a correlation of different ones of the stored diagnostic reports with a failure, which has occurred;
collecting applied measures for curing the failure, which has occurred, associating the applied measures with the particular failure pictures and storing the applied measures in the database;
creating success evaluations for the particular, stored, applied measures, wherein a success evaluation provides a measure for the effectiveness of the particular, stored, applied measure;
in the case of occurrence of at least one newly arising diagnostic report from at least one of the plurality of field devices, comparing such with the failure pictures stored in the database and displaying a proposal of at least one measure appropriate therefor and a corresponding success evaluation.

Referred to as process location is a part of the plant of automation technology, in which a certain process is being executed. A process location can include one or more applications. Referred to as process application here is an application within the process location, for example, flow measurement of a medium.

An advantage of the method of the invention is that through the plurality of field devices and the data collected from them a great accumulated experience relative to the measures to be performed in the case of an occurrence of diagnostic reports is created. The method enables thereby experience based decision aids for the occurrence of diagnostic reports and the failure pictures derived therefrom. In this way, a time consuming analysis of the affected field device and/or of the total associated plant by a maintenance expert is avoided. Moreover, the accumulated experience and the options for treatment are made centrally accessible and are available not, such as previously, only to isolated maintenance experts.

Furthermore, the downtime risk of a field device and/or the associated plant is reduced by prompt curing of an arisen problem.

Not every failure picture is critical, however. From the stored success evaluations of the applied measures, it can also be evident that, in the case of certain diagnostic reports and the failure pictures produced therefrom, no measure is necessary. This prevents possible removal of a field device seemingly threatening to break down, whereby time and costs are saved.

A preferred variation of the method of the invention provides that, based on the comparing of the new diagnostic report with the failure pictures stored in the database, a possible failure is predicted. In this way, also failures can be predicted, which are not directly perceivable from the diagnostic reports, this, thus, leading to a fast and effective problem solution.

An especially preferred embodiment of the method of the invention provides that, supplementally, a probable timeframe of the occurrence of the possible failure is predicted.

Thus, from the stored failure pictures, it can, for example, be evident that a certain failure of different field devices of the same field device type occurs, for example, a few days after occurrence of certain diagnostic reports. Thus, there is a high probability that the same failure will occur in the case of another field device of the same field device type, also in the case of this field device within a few days after issue of the certain diagnostic reports.

An evaluation of the failure, especially as a function of time, permits planning for removal of the failure, for example, scheduling for a next maintenance cycle. This avoids an often unnecessary plant shutdown.

In an advantageous further development of the method of the invention, the success probabilities of all measures applied for a particular failure picture are ascertained and displayed together. In this way, the quality of the measures can be evaluated, this enabling a plant operator to select the measure, which promises the greatest success.

An especially preferred embodiment of the method of the invention provides that the success probabilities of all measures applied for a particular failure picture are ascertained and displayed together for different plant types, such as, for example, plants of the same application, plants of a customer, plants of an equal application, plants of an industry and/or all available plants. In this way, in given cases, a very great accumulated experience can be constructed, which embodies the method of the invention yet more efficiently.

In a preferred variant of the method of the invention, the one of the plurality of field devices applies the measure suitable for the newly arisen diagnostic report automatically.

Furthermore, the object is achieved by a system suitable for performing the method of the invention, comprising
a plurality of field devices;
a database for storing particular device types of the plurality of field devices, diagnostic reports of the plurality of field devices, failure pictures, measures applied in the past for removing a failure, which has occurred, and success evaluations for the particular, stored measures;
a computing unit, which accesses the database and can read out, store and/or associate data there, as well as creates success evaluations and compares new diagnostic reports with failure pictures stored in the database and displays a proposal of a measure appropriate therefor and its success evaluation.

An especially advantageous embodiment of the system of the invention provides that the database is reachable by means of cloud computing web services. The terminology, cloud computing, means, in this case, the storing of data in a remote computer center, in this case, in a remote database. An advantage is that a centralizing of the data occurs, since each field device stores its data in the form of device types and diagnostic reports in this database.

Transmission of data of the plurality of field devices, in particular, device types and diagnostic reports, occurs via one or more networks, to which the field devices are connected. In principle, any conventional protocol of a WAN- or LAN network can be used for this. However, also a fieldbus network of automation technology, such as Foundation Fieldbus®, Profibus®, HART®, ModBus®, etc. can be used, which is connected, for example, with the Internet via a gateway.

The invention will now be explained in greater detail based on the appended drawing, the sole FIGURE of which shows as follows:

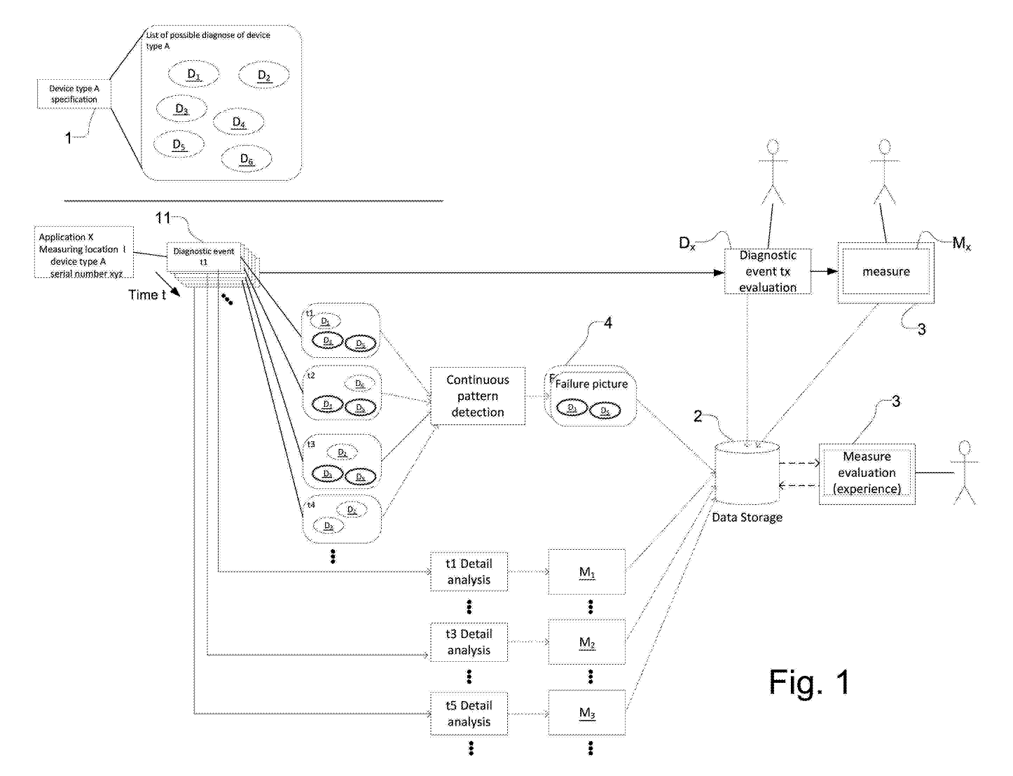

FIG. 1 an embodiment of the method of the invention for maintenance of a plurality of field devices.

FIG. 1 shows an embodiment of the method of the invention for maintenance of a plurality of field devices F. Registered and stored in a database 2 for a certain automation application and its process locations are the device types 1 of each of the plurality of field devices F. The database 2 is located in a cloud, which the plurality of field devices F can access. The transmission of the device types of the plurality of field devices F, and later also the transmission of the diagnostic reports D₁, D₂, D₃, D₄, D₅, D₆, occurs via one or more networks, to which the plurality of field devices F is connected. In principle, used for this can be any protocol of a WAN- or LAN network. However, also a fieldbus network of automation technology, such as Foundation Fieldbus®, Profibus®, HART®, ModBus®, etc., can be used.

After the storing of the device types 1, diagnostic reports D₁, D₂, D₃, D₄, D₅, D₆ from each of the plurality of field devices F are registered, associated with the particular device type 1 and likewise stored in the database 2.

Then, the data stored in the database 2, composed of the diagnostic reports D₁, D₂, D₃, D₄, D₅, D₆ associated with the device types 1, are analyzed. In the example of an embodiment shown in FIG. 1, the axis t is a timeline, which shows the occurrence of diagnostic reports D₁, D₂, D₃, D₄, D₅, D₆ of a certain field device type 1 in a plant. The arising diagnostic reports D₁, D₂, D₃, D₄, D₅, D₆ are analyzed, examined for patterns and, when suitable, summarized in failure pictures 4.

Following this, already applied measures M₁, M₂, M₃ are collected, which have been applied for curing the particular failure. These measures are likewise stored in the database 2. A computing unit creates success evaluations for the applied measures M₁, M₂, M₃, wherein a success evaluation shows a measure for the effectiveness of the particular, stored, applied measure (M₁, M₂, M₃).

If a new diagnostic report Dₓ issues, then a comparison with the failure pictures 4 stored in the database 2 occurs. If at least one match is found, then this is displayed 3 to the plant operator 5. The plant operator 5 receives information concerning a suitable measure Mₓ, which can be performed for removing the problem, and, supplementally, a success evaluation of such measure Mₓ.

An example of a diagnostic report Dₓ is a report of a flow measuring device, which reports that the measured volume flows are steadily lessening over a longer period of time. One or more failure pictures 4 contain this diagnostic report Dₓ and are relevant for the plant operator. A measure Mₓ, which is associated with one of the failure pictures, is cleaning the pipe or tube, through which the flow is occurring. An embodiment of the method of the invention permits a prediction of possible failure, in this case, the forming of deposits in the pipe or tube.

In an embodiment of the method of the invention, the success probabilities of all measures (M₁, M₂, M₃) applied for a particular failure picture (4) are ascertained for the plant and displayed together to the plant operator 5. With approval of a plant operator, the information registered in the database can also be combined with additional information. In this way, the experience based measure proposals can be supplementally expanded, for example, to other plants of the plant operator, to other plants of an industry and/or to all available plants, in order to obtain an as large as possible, accumulated experience.

### LIST OF REFERENCE CHARACTERS

1 field device type
2 database
3 display of a proposed measure
4 failure picture
D₁, D₂, D₃, D₄, D₅, D₆ diagnostic reports
Dₓ newly arisen diagnostic report
F field device
M₁, M₂, M₃ applied measures
Mₓ measure suitable for newly arisen diagnostic report
t time axis

1-8. (canceled)

9. A method for maintenance of at least one field device in a plant of automation technology, comprising:
storing a process location of the at least one field device in a database;
associating a process application to the process location in the database;
registering a device type of the at least one field device and storing the device type in the database;
registering diagnostic reports of the at least one field device, associating the diagnostic reports with the device type, and storing the diagnostic reports in the database;
creating from the stored diagnostic reports failure pictures correlating the stored diagnostic reports with a failure, and storing the failure pictures in the database;
collecting applied measures for curing the failure, associating the applied measures with failure pictures associated with the failure, and storing the applied measures in the database;
creating a success evaluation for each stored applied measure, wherein the success evaluation provides a measure for the effectiveness of the respective stored applied measure, and storing the success evaluation in the database;
upon an occurrence of a newly arising diagnostic report from the at least one field device, comparing the newly arising diagnostic report with failure pictures stored in the database, and displaying a proposal of at least one applied measure appropriate for the newly arising diagnostic report and a corresponding success evaluation.

10. The method as claimed in claim 9, further comprising:
predicting a possible failure of the at least one field device based on the comparing of the newly arising diagnostic report with failure pictures stored in the database.

11. The method as claimed in claim 10, further comprising:
predicting a probable timeframe of the occurrence of the possible failure of the at least one field device.

12. The method as claimed in claim 9, further comprising:
ascertaining and displaying together the success evaluations of all applied measures for a particular failure picture.

13. The method as claimed in claim 12, wherein the success evaluations of all applied measures for a particular failure picture are ascertained and displayed together for plants of a same application, plants of a customer, plants of an equal application, plants of an industry, and/or all available plants.

14. The method as claimed in claim 9, further comprising:
the at least one field device applying automatically the at least one applied measure suitable for the newly arising diagnostic report.

15. A system for performing a method for maintenance of at least one field devices in a plant of automation technology, comprising:
a plurality of field devices;
a database configured to store a device type of the at least one field device, diagnostic reports of the at least one field device, failure pictures, measures previously applied for removing a failure, and success evaluations for the stored, previously applied measures;
a computing unit configured to access the database and read out, store and/or associate data in the database, create success evaluations, compare new diagnostic reports with failure pictures stored in the database, and display a proposal of a measure appropriate the new diagnostic reports and a success evaluation of the proposal.

16. The system as claimed in claim 15, wherein the database is reachable using cloud computing web services.
